(19) United States
(12) Patent Application Publication
(10) Pub. No.: US 2025/0239960 A1
(43) Pub. Date: Jul. 24, 2025

(54) COMBINED ROOF-BASED ENERGY GENERATION SYSTEM

(71) Applicant: A&C FUTURE, INC., Irvine, CA (US)

(72) Inventors: Phil R. Schmidt, Huntington Beach, CA (US); Jose Carrasco, Newport Beach, CA (US); Yenchang Lin, Irvine, CA (US); Pengcheng Wang, Irvine, CA (US); Shoue Chen, Irvine, CA (US); Han Qin, Newport Beach, CA (US); Jiayang Qin, Newport Beach, CA (US)

(21) Appl. No.: 18/419,821

(22) Filed: Jan. 23, 2024

(51) Int. Cl. H02S 10/10; B60L 8/00; B60L 53/51; B60L 53/52; H02S 30/20

(52) U.S. Cl. CPC H02S 10/10; B60L 8/003; B60L 8/006; B60L 53/51; B60L 53/52; H02S 30/20

(57) ABSTRACT

A roof-based system for electric vehicles can be equipped with an array of wind turbines and expandable solar panels that are designed to generate electricity for the operation of electric vehicle. The wind turbines can harness the power of the wind while the vehicle is driving, and the solar panels can be fully extended when the vehicle is parked, maximizing the conversion of solar energy into electrical power. The generated energy can then be stored in the vehicle's batteries, serving a dual purpose: it can either propel the electric vehicle or supply power for daily energy needs. This innovative roofing system represents a sustainable and eco-friendly solution that not only promotes renewable energy usage but also enhances the overall efficiency and eco-friendliness of electric vehicles.

### BACKGROUND OF THE INVENTION

### 1. Field of the Invention

Embodiments of the invention relate generally to renewable energy systems. More particularly, embodiments of the invention relate to an electric based vehicle having a roof-based energy generation system.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Electric-based vehicles can provide an alternative to fossil fuel-based vehicles. However, the overall range of such vehicles can create a cause for concern, limiting the adoption of such vehicles.

Further, other electric-based vehicles, such as recreational vehicles, may use electricity for many of its functions. The power for these vehicles is often supplied by a battery bank that can be charged when the vehicle is attached to grid power. However, when such a power source is not available, the batteries may quickly drain, leaving the user without certain features of the recreational vehicle.

In view of the foregoing, there is a need for an energy generation system that can be used for power in electric-based vehicles.

### SUMMARY OF THE INVENTION

Embodiments of the present invention aim to solve the aforementioned problems in conventional electric vehicles by providing a roof-mounted energy generation system including an array of solar panels and a wind-based electric generation system.

Embodiments of the present invention provide a vehicle energy generation system comprising a roof-mounted array of solar panels operable to store stacked on top of each other in a folded state, the array of solar panels further operable to expand to an expanded state to expose a top face of each panel; and a roof-mounted set of wind turbine fans operable to turn to generate electricity.

In some embodiments, the set of wind turbine fans are disposed at a front edge of a roof surface of a vehicle.

In some embodiments, one or more solar panels in the array of solar panels extend beyond a side edge of the roof when in the expanded state.

In some embodiments, each solar panel of the array of solar panels are disposed within an outer periphery of a roof surface of the vehicle when in the folded state.

In some embodiments, the array of solar panels includes a first array of solar panels and a second array of solar panels.

In some embodiments, one or more solar panels in the first array of solar panels extend beyond a first side edge of the a roof surface when in the expanded state and one or more solar panels in the second array of solar panels extend beyond a second, opposite side edge of the roof surface when in the expanded state.

In some embodiments, the vehicle energy generation system further includes a first solar array movement mechanism disposed at a first end of the array of solar panels; and a second solar array movement mechanism disposed at a second, opposite end of the array of solar panels, wherein each of the first and second solar array movement mechanisms interconnect each solar panel of the array of solar panels at respective ends thereof.

In some embodiments, each of the first and second solar array movement mechanisms include a driven arm rotatable to move the array of solar panels between the folded state and the expanded state.

In some embodiments, the vehicle energy generation system further includes a drive motor attached to the driven arm to rotate the driven arm.

In some embodiments, each of the first and second solar array movement mechanisms include a first solar panel attachment member attached to ends of a first solar panel of the array of solar panels; a second solar panel attachment member attached to ends of a second solar panel of the array of solar panels; a third solar panel attachment member attached to ends of a third solar panel of the array of solar panels; a driven linkage connecting the first solar panel attachment member with the second solar panel attachment member; a central linkage interconnecting each of the first, second and third solar panel attachment members; and an outer linkage connecting the second solar panel attachment member with the third solar panel attachment member.

Embodiments of the present invention provide a vehicle energy generation system comprising a roof-mounted first array of solar panels operable to store stacked on top of each other in a folded state, the first array of solar panels further operable to expand to an expanded state to expose a top face of each panel; a roof-mounted second first array of solar panels operable to store stacked on top of each other in a folded state, the second first array of solar panels further operable to expand to an expanded state to expose a top face of each panel; and a roof-mounted set of wind turbine fans operable to turn to generate electricity, wherein each solar panel of the first and second arrays of solar panels are disposed within an outer periphery of a roof surface of the vehicle when in the folded state; and one or more solar panels in the first array of solar panels extend beyond a first side edge of the a roof surface when in the expanded state and one or more solar panels in the second array of solar panels extend beyond a second, opposite side edge of the roof surface when in the expanded state.

Embodiments of the present invention provide a vehicle energy generation system comprising a roof-mounted array of solar panels operable to store stacked on top of each other in a folded state, the array of solar panels further operable to expand to an expanded state to expose a top face of each panel; a roof-mounted set of wind turbine fans operable to turn to generate electricity; a first solar array movement mechanism disposed at a first end of the array of solar panels; a second solar array movement mechanism disposed at a second, opposite end of the array of solar panels, wherein each of the first and second solar array movement mechanisms interconnect each solar panel of the array of solar panels at respective ends thereof; a driven arm of each of the first and second solar array movement mechanisms is rotatable to move the array of solar panels between the folded state and the expanded state; and a drive motor attached to the driven arm to rotate the driven arm.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a vehicle having a roof-based energy generation system, in a folded/travel state, according to an exemplary embodiment of the present invention;

FIG. 2 illustrates a perspective view of the vehicle of FIG. 1, with the roof-based energy generation system in a partially expanded state;

FIG. 3 illustrates a perspective view of the vehicle of FIG. 1, with the roof-based energy generation system in a fully expanded/parked state;

FIG. 4 illustrates a perspective view of a solar array of the roof-based energy generation system of FIG. 1, in the folded state;

FIG. 5 illustrates a detailed perspective view of a drive motor for opening and closing the solar array of FIG. 4;

FIG. 6 illustrates a side view of a solar array movement mechanism used in the solar array of FIG. 4, in a folded state;

FIG. 7 illustrates a side view of the solar array movement mechanism of FIG. 6 in a partially expanded state;

FIG. 8 illustrates a side view of the solar array movement mechanism of FIG. 6 in a fully expanded state;

FIG. 9 illustrates a detailed perspective view of the solar array movement mechanism attached to solar panels of the solar array in the folded state;

FIG. 10 illustrates a detailed perspective view of the solar array movement mechanism of FIG. 9, in the partially expanded state; and

FIG. 11 illustrates a detailed perspective view of the solar array movement mechanism of FIG. 9, in the fully expanded state.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide an innovative roof system for electric vehicles, equipped with an array of wind turbines and expandable solar panels designed to generate electricity for the operation of electric vehicles. The wind turbines can harness the power of the wind while the vehicle is driving, and the solar panels can be fully extended when the vehicle is parked, maximizing the conversion of solar energy into electrical power. The generated energy can then be stored in the vehicle's batteries, serving a dual purpose: it can either propel the electric vehicle or supply power for daily energy needs. This innovative roofing system represents a sustainable and eco-friendly solution that not only promotes renewable energy usage but also enhances the overall efficiency and eco-friendliness of electric vehicles.

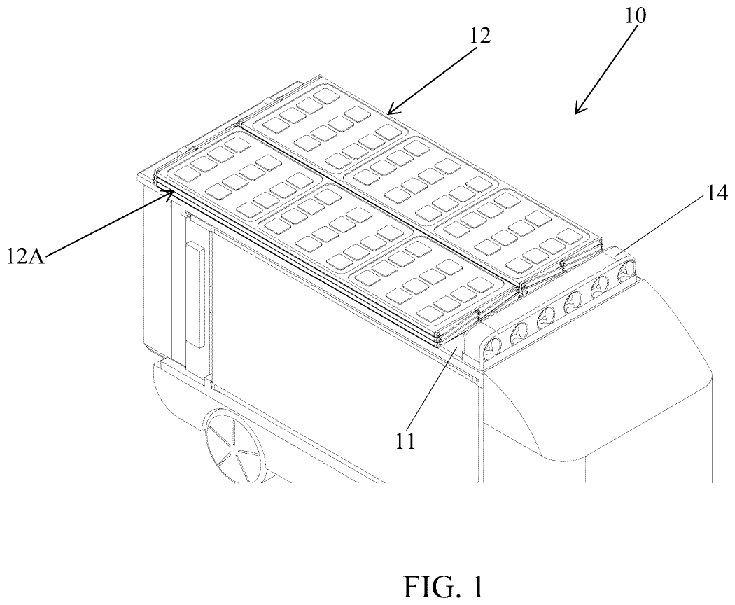

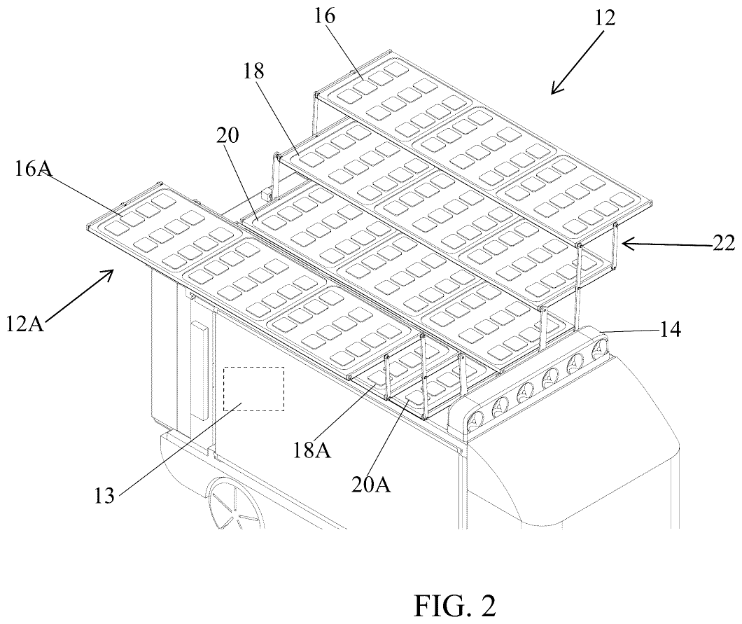

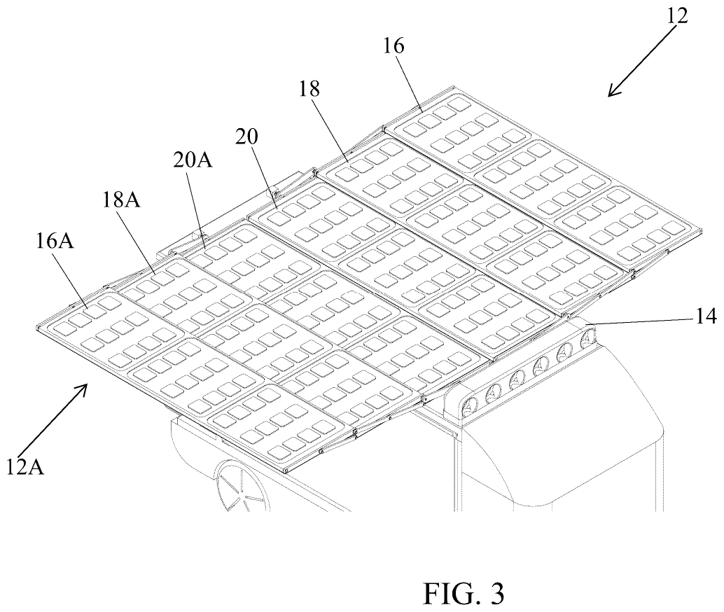

Referring now to FIGS. 1 through 3, a vehicle 10 can include, on its roof 11, a solar array 12 and a wind-based power generation system 14. The solar array can include two solar arrays 12, 12A, positioned on opposite sides of the vehicle 10. Each of the solar arrays 12, 12A can include a plurality of solar panels, such as an upper solar panel 16, one or more middle solar panels 18, and a base solar panel 20. A solar array movement mechanism 22, as described in greater detail below, can be used to move the solar arrays 12, 12A between a folded/travel position (FIG. 1) and an expanded/parked position (FIG. 3).

In the folded position, only the upper solar panel 16 of each solar array 12, 12A may be able to receive direct sunlight. In the expanded position, each solar panel 16, 18, 20 is able to receive direct sunlight.

Thus, when the vehicle 10 is moving, the upper panel 16 of each solar array 12, 12A may generate power. Further, the wind-based power generation system 14 may include a plurality of fans 14A that may turn due to wind created during motion of the vehicle 10. Such turning of the fans 14A may be used to generate electricity by methods known in the art.

The vehicle 10 may be an electric-based vehicle that relies on power for motion, such as an electric vehicle, a plug-in hybrid electric vehicle, or the like. With this type of vehicle, the energy generation system of the present invention can generate power while the vehicle is moving and when the vehicle is parked to charge the batteries of the vehicle and to extend the range of the vehicle to operate. In some embodiments, the vehicle 10 may be of the type that relies on electric power for various functions. Such vehicles can include, for example, a recreational vehicle. The energy generation system of the present invention can be useful for such vehicles to provide power to charge house batteries during motion and while parked. Such can be especially useful during boondocking with the recreational vehicle, where the user can park the vehicle in areas without an available connection to grid power.

The vehicle 10 can include the appropriate electronics 13, as may be known in the art, to provide the ability to receive power from the wind-based power generation system 14 and the solar arrays 12, 12A and use such power to charge the batteries, provide propulsion for the vehicle and/or provide electricity to components of the vehicle. Such electronics 13 can include power conditioners, to provide the appropriate voltage and/or current, power distributors, to provide power to the appropriate components, and the like.

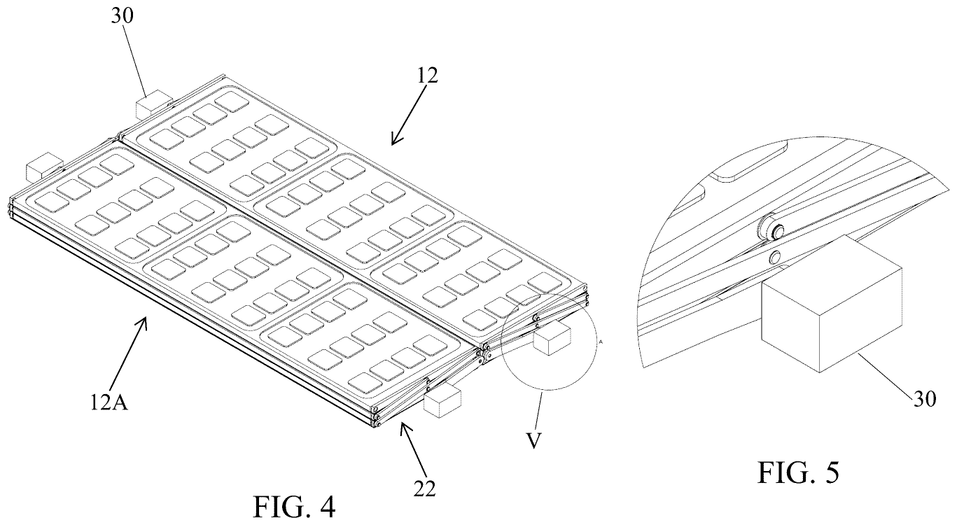

Referring to FIGS. 4 and 5, the solar arrays 12, 12A may be connected to the solar array movement mechanism 22 and a drive motor 30 may be used to drive the solar array movement mechanism 22 to open and close the solar arrays 12, 12A. As described in greater detail below, the drive motor 30 may be connected to rotate a driven arm 32 which, in turns, moves each solar panel 16, 18, 20 of the solar array 12, for example. Four solar array movement mechanisms 22, one at each lengthwise end of each of the solar arrays 12, 12A, may be provided. Four drive motors 30, one at each of the solar array movement mechanisms 22 can be used for moving each of the solar array movement mechanisms 22 simultaneously and synchronous manner.

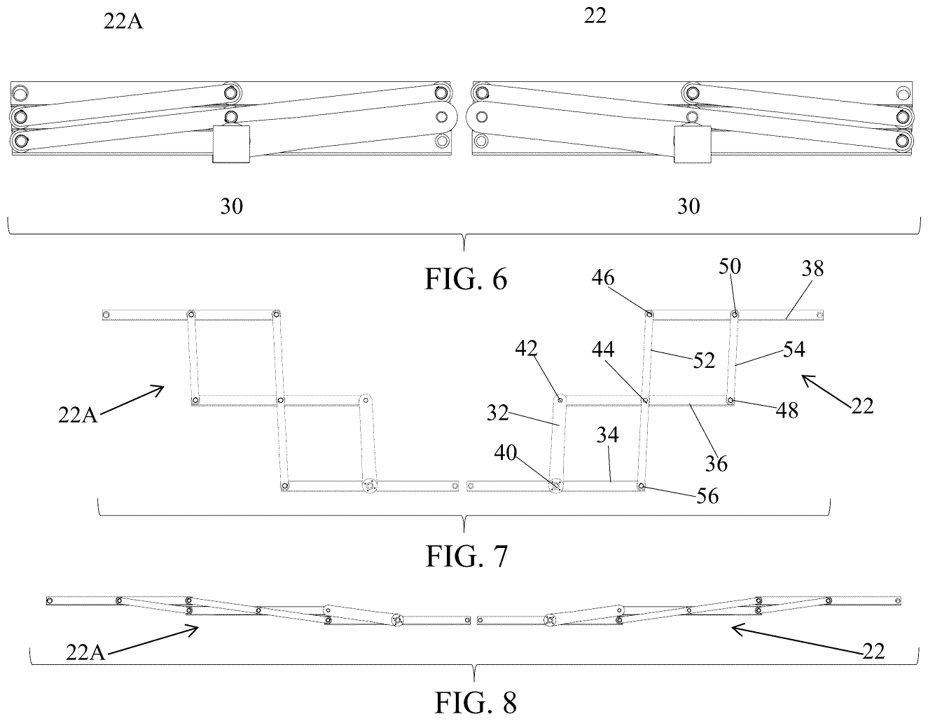

Referring now to FIGS. 6 through 11, the solar arrays 12, 12A (see FIG. 1) can be moved between the folded and expanded states with respective solar array movement mechanisms 22, 22A. It should be understood that each of the solar array movement mechanisms, 22, 22A may operate in a similar (but mirror opposite) manner.

Focusing on the solar array movement mechanism 22, the components will be discussed with reference to FIG. 7. A base solar panel attachment member 34 may be attached to end of the base solar panel 20, a middle solar panel attachment member 36 may be attached to the end of the middle solar panel 18 and an upper solar panel attachment member 38 may be attached to the end of the upper solar panel 16. The drive motor 30 (see FIGS. 4 and 5) may attach to shaft 60. The shaft 60 may be fixed to the driven arm 32 so that turning the shaft 60 with the drive motor 30 causes the driven arm 32 to rotate about pivot axis 40. The base solar panel attachment member 34 may pivotably attach, at pivot axis 40, to a proximate end of the driven arm 32 at a central location along its length.

The distal end (relative to the shaft 60) of the driven arm 32 may be pivotably attached to a medial end of the middle solar panel attachment member 36 at pivot axis 42. A central arm 52 may span from a pivotable connection (at pivot axis 56) at the lateral end of the base solar panel attachment member 34, to a pivotable connection (at pivot axis 44) about midway along the length of the central arm 52 at a central lengthwise location of the middle solar panel attachment member 36, to a pivotable connection (at pivot axis 46) at a medial end of the upper solar panel attachment member 38. As can best be seen in FIG. 7, a length of the central arm 52 may be about twice that of the driven arm 32 (and also about twice that of the upper arm 54, described below). The upper arm 54 can pivotably connect (at pivot axis 48) to the lateral end of the middle solar panel attachment member 36 at one end thereof, and can pivotably connect (at pivot axis 50) to a central location along the length of the upper solar panel attachment member 38.

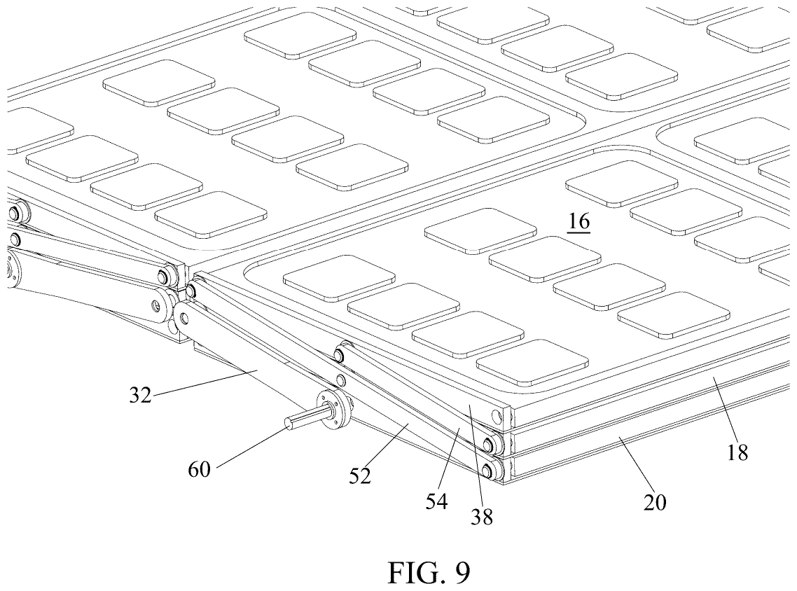

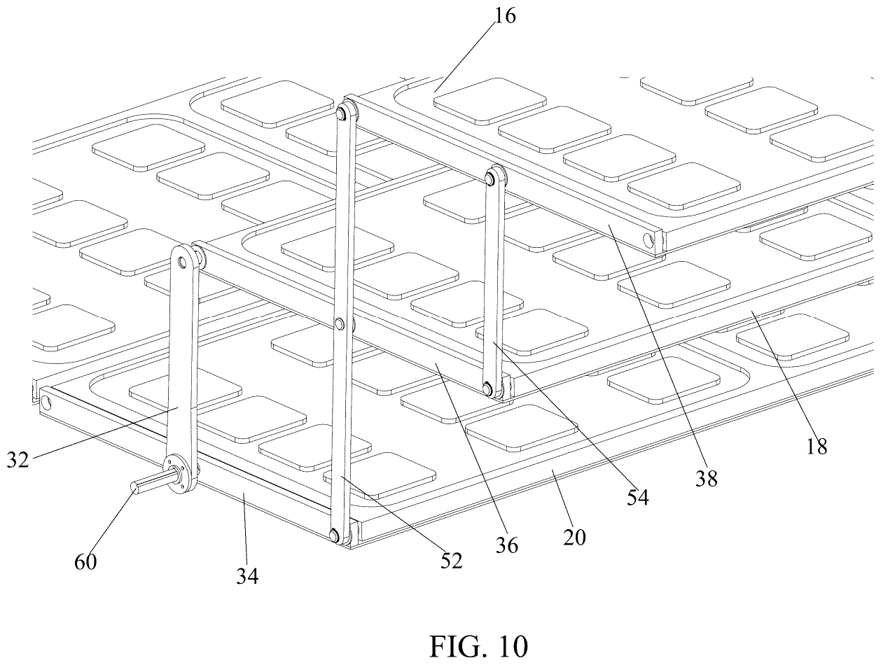

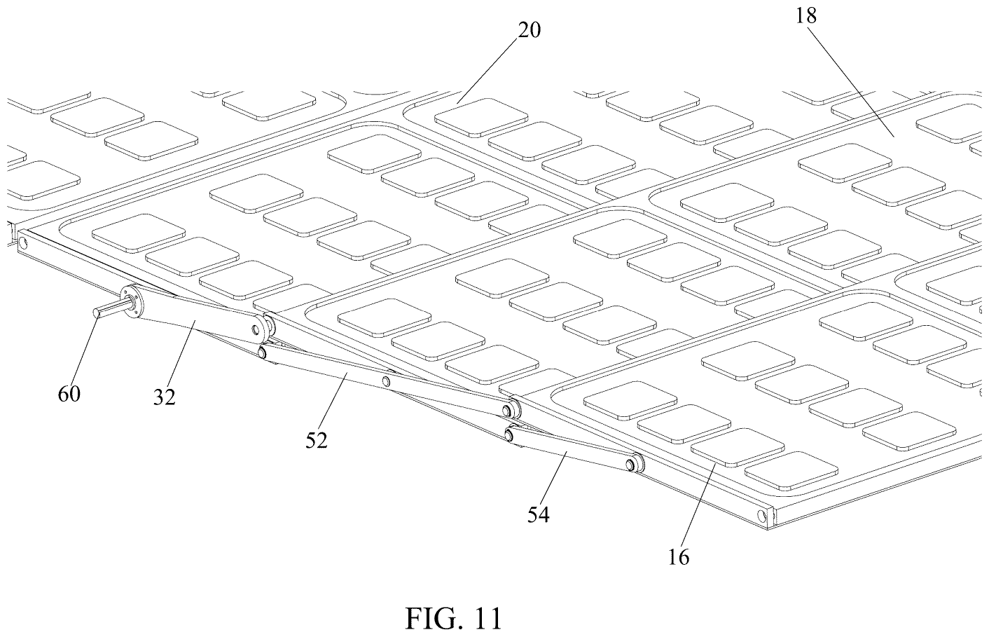

Thus, as the driven arm 32 is rotated, the remaining arms move from the folded state as shown in FIGS. 6 and 9, to an intermediate state, as shown in FIGS. 7 and 10, to an expanded state, as shown in FIGS. 7 and 11.

In some embodiments, the arms 32, 52, 54 are sized with a sufficient length so that there is no overlap between the solar panels 16, 18, 20 when in the expanded state. In some embodiments, the arms 32, 52, 54 are sized with a sufficient length so that there is minimal overlap between the solar panels 16, 18, 20 when in the expanded state. Such overlap may have no effect on the power generated by the solar panels 16, 18, 20 or may have only minimal effect on the overall generated power.

While two solar arrays 12, 12A are illustrated, it should be understood that a single solar array may be used, where such array expands outward at only one side of the vehicle. Further, for vehicles of sufficient length, multiple solar arrays, placed end-to-end, may be used.

While only one middle solar panel 18 is shown, it should be understood that more than one middle solar panel may be used within the scope of the present invention. The structure of the solar array movement mechanisms 22 may be configured with additional arms to provide such additional middle solar panels. In any event, it should be understood that the middle solar panel(s) 18 are sandwiched between the upper solar panel 16 and the base solar panel 20 when folded.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A vehicle energy generation system comprising:
a roof-mounted array of solar panels operable to store stacked on top of each other in a folded state, the array of solar panels further operable to expand to an expanded state to expose a top face of each panel; and
a roof-mounted set of wind turbine fans operable to turn to generate electricity.

2. The vehicle energy generation system of claim 1, wherein the set of wind turbine fans are disposed at a front edge of a roof surface of a vehicle.

3. The vehicle energy generation system of claim 1, wherein one or more solar panels in the array of solar panels extend beyond a side edge of the roof when in the expanded state.

4. The vehicle energy generation system of claim 3, wherein each solar panel of the array of solar panels are disposed within an outer periphery of a roof surface of the vehicle when in the folded state.

5. The vehicle energy generation system of claim 1, wherein the array of solar panels includes a first array of solar panels and a second array of solar panels.

6. The vehicle energy generation system of claim 5, wherein one or more solar panels in the first array of solar panels extend beyond a first side edge of the roof surface when in the expanded state and one or more solar panels in the second array of solar panels extend beyond a second, opposite side edge of the roof surface when in the expanded state.

7. The vehicle energy generation system of claim 1, further comprising:
a first solar array movement mechanism disposed at a first end of the array of solar panels; and
a second solar array movement mechanism disposed at a second, opposite end of the array of solar panels,
wherein each of the first and second solar array movement mechanisms interconnect each solar panel of the array of solar panels at respective ends thereof.

8. The vehicle energy generation system of claim 7, wherein each of the first and second solar array movement mechanisms include a driven arm rotatable to move the array of solar panels between the folded state and the expanded state.

9. The vehicle energy generation system of claim 8, further comprising a drive motor attached to the driven arm to rotate the driven arm.

10. The vehicle energy generation system of claim 7, wherein each of the first and second solar array movement mechanisms include:
a first solar panel attachment member attached to ends of a first solar panel of the array of solar panels;
a second solar panel attachment member attached to ends of a second solar panel of the array of solar panels;
a third solar panel attachment member attached to ends of a third solar panel of the array of solar panels;
a driven linkage connecting the first solar panel attachment member with the second solar panel attachment member;
a central linkage interconnecting each of the first, second and third solar panel attachment members; and
an outer linkage connecting the second solar panel attachment member with the third solar panel attachment member.

11. A vehicle energy generation system comprising:
a roof-mounted first array of solar panels operable to store stacked on top of each other in a folded state, the first array of solar panels further operable to expand to an expanded state to expose a top face of each panel;
a roof-mounted second first array of solar panels operable to store stacked on top of each other in a folded state, the second first array of solar panels further operable to expand to an expanded state to expose a top face of each panel; and
a roof-mounted set of wind turbine fans operable to turn to generate electricity, wherein:
each solar panel of the first and second arrays of solar panels are disposed within an outer periphery of a roof surface of the vehicle when in the folded state; and
one or more solar panels in the first array of solar panels extend beyond a first side edge of the a roof surface when in the expanded state and one or more solar panels in the second array of solar panels extend beyond a second, opposite side edge of the roof surface when in the expanded state.

12. The vehicle energy generation system of claim 11, wherein the set of wind turbine fans are disposed at a front edge of a roof surface of a vehicle.

13. The vehicle energy generation system of claim 11, further comprising:
a first solar array movement mechanism disposed at a first end of each of the first and second arrays of solar panels; and
a second solar array movement mechanism disposed at a second, opposite end of each of the first and second arrays of solar panels,
wherein each of the first and second solar array movement mechanisms interconnect each solar panel of respective ones of the first and second arrays of solar panels at respective ends thereof.

14. The vehicle energy generation system of claim 13, wherein each of the first and second solar array movement mechanisms include a driven arm rotatable to move the first and second arrays of solar panels between the folded state and the expanded state.

15. The vehicle energy generation system of claim 14, further comprising a drive motor attached to the driven arm to rotate the driven arm.

16. The vehicle energy generation system of claim 13, wherein each of the first and second solar array movement mechanisms include:
a first solar panel attachment member attached to ends of a first solar panel of the array of solar panels;
a second solar panel attachment member attached to ends of a second solar panel of the array of solar panels;
a third solar panel attachment member attached to ends of a third solar panel of the array of solar panels;
a driven linkage connecting the first solar panel attachment member with the second solar panel attachment member;
a central linkage interconnecting each of the first, second and third solar panel attachment members; and
an outer linkage connecting the second solar panel attachment member with the third solar panel attachment member.

17. A vehicle energy generation system comprising:
a roof-mounted array of solar panels operable to store stacked on top of each other in a folded state, the array of solar panels further operable to expand to an expanded state to expose a top face of each panel;
a roof-mounted set of wind turbine fans operable to turn to generate electricity;
a first solar array movement mechanism disposed at a first end of the array of solar panels;
a second solar array movement mechanism disposed at a second, opposite end of the array of solar panels, wherein each of the first and second solar array movement mechanisms interconnect each solar panel of the array of solar panels at respective ends thereof;
a driven arm of each of the first and second solar array movement mechanisms is rotatable to move the array of solar panels between the folded state and the expanded state; and
a drive motor attached to the driven arm to rotate the driven arm.

18. The vehicle energy generation system of claim 17, wherein each of the first and second solar array movement mechanisms include:
a first solar panel attachment member attached to ends of a first solar panel of the array of solar panels;
a second solar panel attachment member attached to ends of a second solar panel of the array of solar panels;
a third solar panel attachment member attached to ends of a third solar panel of the array of solar panels;
a driven linkage connecting the first solar panel attachment member with the second solar panel attachment member;
a central linkage interconnecting each of the first, second and third solar panel attachment members; and
an outer linkage connecting the second solar panel attachment member with the third solar panel attachment member.

19. The vehicle energy generation system of claim 17, wherein:
one or more solar panels in the array of solar panels extend beyond a side edge of the roof when in the expanded state; and
each solar panel of the array of solar panels are disposed within an outer periphery of a roof surface of the vehicle when in the folded state.

20. The vehicle energy generation system of claim 17, wherein:
the array of solar panels includes a first array of solar panels and a second array of solar panels; and
one or more solar panels in the first array of solar panels extend beyond a first side edge of the a roof surface when in the expanded state and one or more solar panels in the second array of solar panels extend beyond a second, opposite side edge of the roof surface when in the expanded state.
